(19) United States
(12) Patent Application Publication
(10) Pub. No.: US 2010/0044002 A1
(43) Pub. Date: Feb. 25, 2010

(54) INDUCTION FURNACE WITH GAS DIFFUSER AND CRUCIBLE AND METHOD THEREFOR

(75) Inventor: Vern Kevin Leffew, Valparaiso, IN (US)

Correspondence Address: HARTMAN & HARTMAN, P.C., 552 EAST 700 NORTH, VALPARAISO, IN, 46383, US

(73) Assignee: URSCHEL LABORATORIES, INC., Valparaiso, IN (US)

(21) Appl. No.: 12/545,165

(22) Filed: Aug. 21, 2009

Related U.S. Application Data
(60) Provisional application No. 61/090,826, filed on Aug. 21, 2008.

(51) Int. Cl. B22D 1/00; B29C 41/02

(52) U.S. Cl. 164/266; 264/319

(57) ABSTRACT

A furnace, a crucible for such a furnace, and a method for preparing and using the crucible. The crucible is formed of a nonmetallic refractory material to have side walls, a base wall, an opening in the base wall, and an interior cavity. A particulate refractory material is packed beneath the base wall and around the side walls of the crucible, and a gas diffuser is positioned beneath the crucible. A solid sintered porous barrier is formed within the opening in the base wall of the crucible and between the gas diffuser and the interior cavity of the crucible. The porous barrier is sufficiently porous to enable a gas exiting the diffuser to flow therethrough and enter the interior cavity of the crucible.

### CROSS REFERENCE TO RELATED APPLICATIONS

This application claims the benefit of U.S. Provisional Application No. 61/090,826, filed Aug. 21, 2008, the contents of which are incorporated herein by reference.

### BACKGROUND OF THE INVENTION

The present invention generally relates to processes for melting materials, and more particularly to a crucible and method utilizing a gas diffuser to promote the purity of a molten material and articles cast therefrom.

An induction furnace 10 equipped with a conventional crucible 12 is represented in FIG. 1. The crucible 12 is disposed within a furnace shell 14 and surrounded by induction coils 16 embedded in a coil grout 18. The crucible 12 has a solid one-piece construction configured to define a cavity 20 sized to contain a desired quantity of molten metallic material, and the induction coils 16 are configured to induce sufficient electric currents within solid metal (not shown) placed in the crucible cavity 20 to melt the metal. For the production of steels and other metal alloys, the crucible 12 is often formed of a high purity alumina to have low porosity. The crucible 12 is shown packed within a particulate refractory material 22 that serves as a safety barrier in the event that a crack 24 develops in the crucible 12. Molten metal within the cavity 20 that leaks through the crack 24 will sufficiently heat the packed refractory material surrounding the crack 24 to cause sintering, effectively healing the crack 24 by forming a solid wall against the outer surface of the crucible 12 surrounding the crack 24. If appropriate, the crucible 12 and furnace 10 can continue to be used until the condition of the crucible 12 warrants replacement, for example, as a result of thinning of the crucible walls due to erosion.

In the production of stainless steels of high purity, furnaces have been equipped with gas diffusers to remove undesirable gasses and promote the suspension of fine impurities, which can then be removed as slag from the surface of the melt. By eliminating impurities, castings can be produced that are substantially free of inclusions and porosity that could render the casting unacceptable for its intended purpose. Nonlimiting examples include components used in food processing equipment, such as equipment produced by Urschel Laboratories.

An induction furnace 30 equipped with a gas diffuser 32 is represented in FIG. 2. For convenience, identical reference numerals are used in FIG. 2 denote the same or equivalent elements described for the induction furnace 10 of FIG. 1. The gas diffuser 32 is adapted to inject a controlled flow of an inert gas, such as argon, in the form of fine bubbles capable of agglomerating and suspending fine impurities in the molten metal within the furnace 30. The gas diffuser 32 is shown as comprising a tube 34 that delivers the inert gas to a porous plug 36, typically formed of a sintered particulate refractory material. In order for the inert gas to be injected into the molten metal, the furnace 30 of FIG. 2 differs from that of FIG. 1 by the use of a metallic sacrificial form 38 (typically formed of the alloy being melted) packed in a particulate refractory material 22 (similar to FIG. 1). As the furnace heats and melts metal placed in the form 38, both the form 38 and the metal within are melted and the resulting molten metal directly contacts the packed refractory material 22 that previously surrounded and contacted the form 38. Similar to the healing effect discussed in reference to FIG. 1, the refractory material 22 contacted by the molten metal sinters, effectively forming a sintered lining in situ which is schematically represented in FIG. 2 and identified with reference number 12 as an equivalent of the crucible 12 in FIG. 1. The sintered lining 12 is sufficiently porous to allow the inert gas to pass therethrough from the porous plug 36 to the molten metal within the cavity 20 of the lining 12. To promote the effectiveness of the inert gas bubbles to agglomerate and suspend fine impurities in the molten metal, the porous plug 36 is preferably placed at or near the center of a base wall 40 of the lining 12, as represented in FIG. 2.

While effective in reducing impurities, a shortcoming of using a gas diffuser 32 as shown with the furnace of FIG. 2 is the durability of the lining 12. The sintered particulate material that forms in situ the lining 12 of FIG. 2 does not resist erosion as well as the dense prefabricated crucible 12 of FIG. 1. Erosion generally occurs as the result of circulation of the molten metal induced by the induction current used to melt the metal and maintain it in a molten state. As a result, the lining 12 of FIG. 2 may require more frequent replacement than the crucible 12 of FIG. 1. Furthermore, in order to produce a strong and rigid lining 12 that will resist crumbling, the sacrificial metal form 38 of FIG. 2 (which may be relatively thin, for example, about ⅛ inch (about 3 mm)) must be heated very slowly (for example, over a period of about eight hours or more) in order to gradually heat and sinter the particulate material 22 surrounding the metal form 38. Finally, the particulate material 22 surrounding the metal form 38 should be carefully packed to further ensure that the lining 12 will have sufficient density for strength yet enough porosity to be readily permeated by the inert gas introduced by the diffuser 32.

### BRIEF DESCRIPTION OF THE INVENTION

The present invention provides a furnace that utilizes a gas diffuser, a crucible for such a furnace, and a method for preparing and using the crucible to promote the purity of a molten material and articles cast therefrom. By eliminating impurities, a casting can be produced from the molten material that is substantially free of inclusions and porosity that might render the casting unacceptable for its intended purpose, a nonlimiting example of which is a component for food processing equipment.

According to a first aspect of the invention, a furnace is provided that includes a shell and a crucible within the furnace shell. The crucible is formed of a nonmetallic refractory material and has side walls, a base wall, an opening in the base wall, and an interior cavity defined by the side and base walls. A particulate refractory material is packed beneath the base wall of the crucible and around the side walls of the crucible. A gas diffuser is beneath the crucible and includes a porous body and a conduit for delivering a gas to the porous body. The porous body of the diffuser is disposed in the particulate material and beneath the opening in the base wall of the crucible, and is sufficiently porous to enable a gas flowing through the conduit to also flow through the porous body and exit an external surface of the porous body. A solid sintered porous barrier is disposed within the opening in the base wall of the crucible and between the porous body of the gas diffuser and the interior cavity of the crucible, and the porous barrier is sufficiently porous to enable the gas exiting the porous body to also flow through the porous barrier and enter the interior cavity of the crucible. The furnace further comprises an apparatus for heating and melting a material placed in the interior cavity of the crucible.

According to a second aspect of the invention, a crucible is provided for use in a furnace that utilizes a gas diffuser to deliver a gas to a molten material within the furnace. The crucible comprises a nonmetallic refractory material that defines side walls, a base wall and an interior cavity defined by the side and base walls. The base wall of the crucible has an opening through which a gas is able to pass from the gas diffuser when located beneath the crucible.

According to another aspect of the invention, a method is provided for preparing and using a crucible. The method entails placing within a furnace shell a solid crucible formed of a nonmetallic refractory material and having an interior cavity defined by side walls and a base wall. The crucible is placed in the furnace shell so that a first particulate refractory material is packed beneath the base wall of the crucible and around the side walls of the crucible, and a second particulate refractory material is packed within an opening in the base wall. The crucible is then heated to melt a material within the cavity and sinter the second particulate refractory material to form a solid sintered porous barrier within the opening in the base wall of the crucible. A gas flows upward through the first particulate refractory material beneath the crucible, through the porous barrier within the opening in the base wall of the crucible, and into the molten material within the cavity of the crucible.

A significant advantage of this invention is the ability to effectively use a gas diffuser to reduce impurities in molten metal within a crucible, yet with the additional benefit of using a crucible that is more durable than linings typically used with gas diffusers. In particular, the crucible can have a dense, one-piece prefabricated construction that is more durable than linings of the type represented in FIG. 2, which are formed in situ by sintering a particulate material. As a result, the crucible is better capable of resisting erosion, more similar to the dense prefabricated crucible 12 of FIG. 1.

Other aspects and advantages of this invention will be better appreciated from the following detailed description.

### BRIEF DESCRIPTION OF THE DRAWINGS

FIGS. 1 and 2 represent induction furnaces equipped with crucibles and linings, respectively, in accordance with the prior art.

FIG. 3 represents an induction furnace equipped with a crucible having a porous barrier within an opening in the base of the crucible, and through which a gas from a gas diffuser beneath the crucible is able to flow in accordance with an embodiment of the invention.

FIG. 4 represents the induction furnace of FIG. 3 prior to heating the crucible to form the porous barrier.

### DETAILED DESCRIPTION OF THE INVENTION

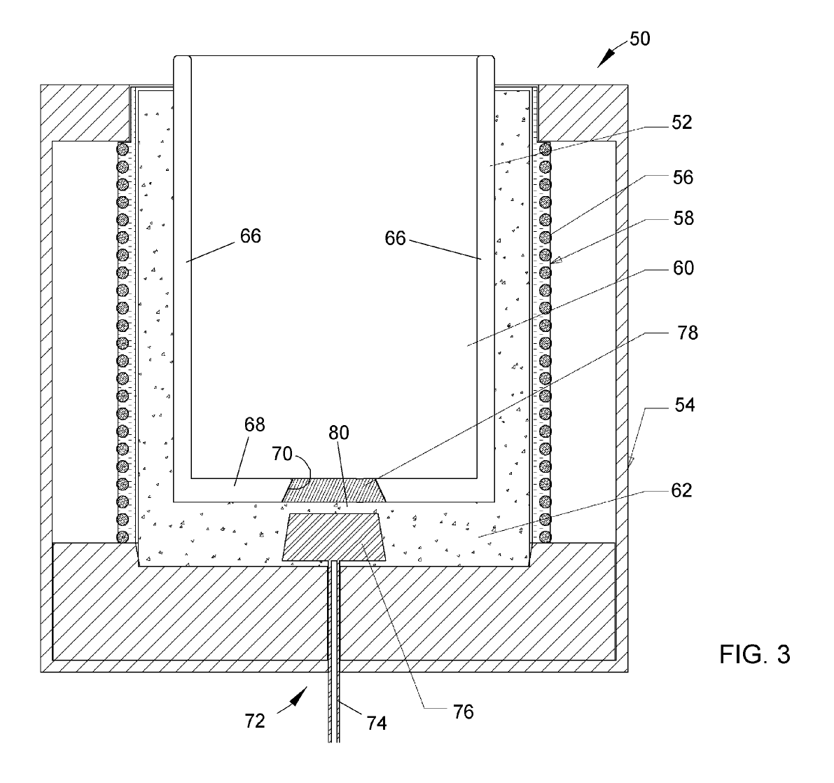

FIG. 3 represents an induction furnace 50 equipped with a crucible 52 and gas diffuser 72 in accordance with the present invention. As known in the art, the furnace 50 is depicted as comprising a shell 54 that contains the crucible 52. The crucible 52 is represented as having a solid one-piece construction configured to define a cavity 60, which can be sized to contain any desired quantity of molten metallic material (not shown). The shell 54 can have any suitable construction and configuration. The furnace 50 is equipped with induction coils 56 embedded in a grout 58 and surrounding the crucible 52. The coils 56 are adapted to induce sufficient electric currents within metal placed in the crucible 52 to melt the metal.

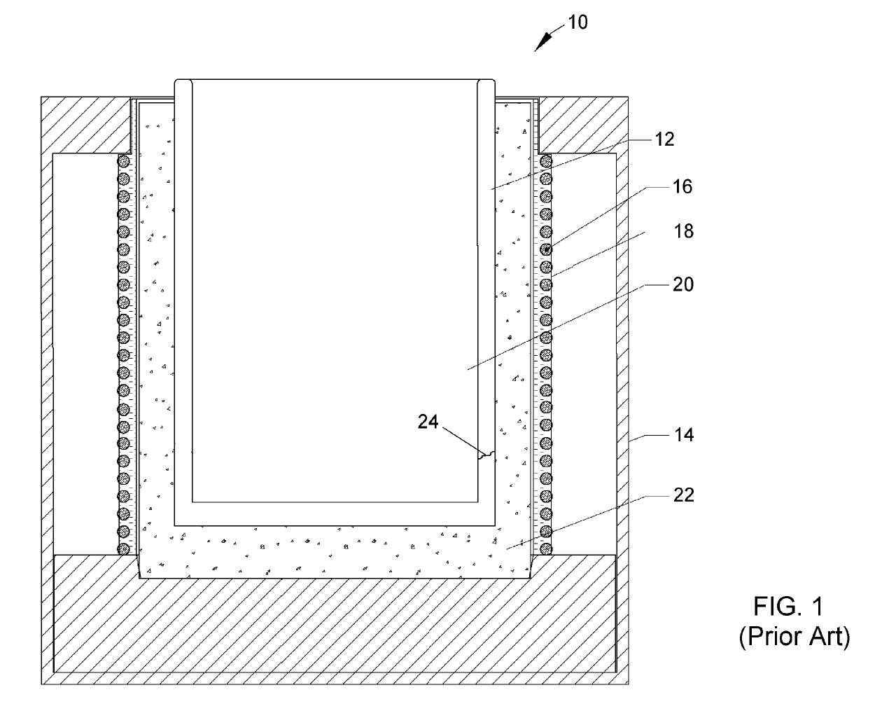

The crucible 52 is preferably prefabricated from a dense refractory material, and then packed in a particulate refractory material 62 that serves as a safety barrier surrounding the side walls 66 and base wall 68 of the crucible 52. Preferred materials for the crucible 52 are nonmetallic materials that will not melt or react with the molten metallic material intended to be contained by the crucible 52. Otherwise, suitable materials for the crucible 52 and the particulate refractory material 62 surrounding the crucible 52 include those known in the art, including high purity alumina noted for the crucible 10 of FIG. 1, and therefore will not be discussed in any detail here.

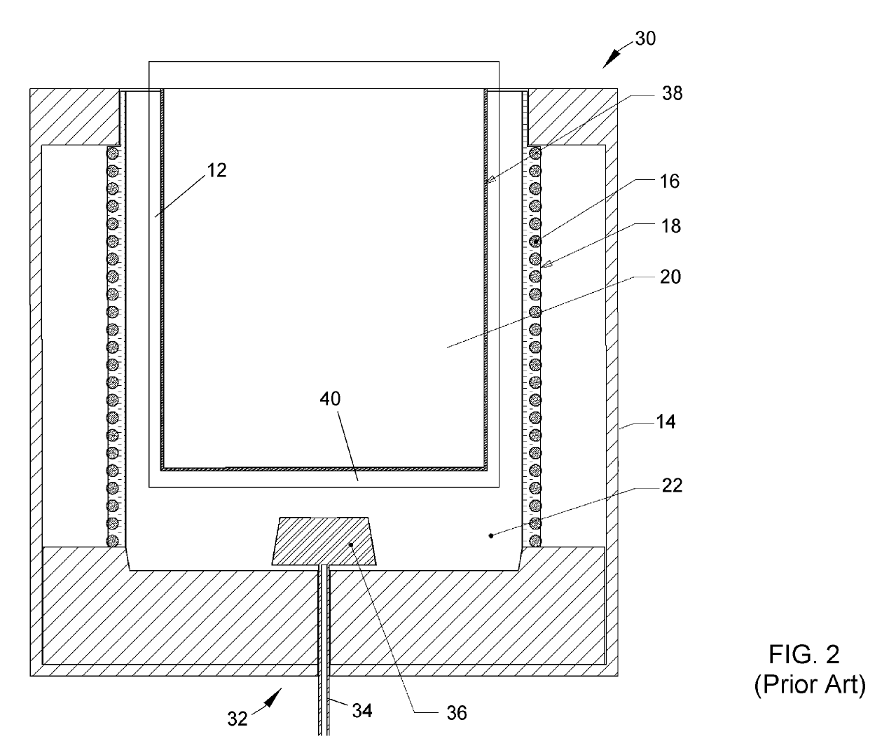

Similar to the furnace 30 of FIG. 2, the gas diffuser 72 is adapted to inject a controlled flow of a gas, preferably an inert gas such as argon, as fine bubbles that agglomerate and suspend fine impurities in the molten metal within the crucible cavity 60, such that the impurities can be removed as slag from the surface of the melt. As in FIG. 2, the gas diffuser 72 is represented as comprising a tube 74 that delivers the inert gas to a porous plug 76, which is packed in the particulate refractory material 62 beneath the base wall 68 of the crucible 52. The porous plug 76 preferably comprises a sintered particulate refractory material within a tapered steel housing. In accordance with known diffusers 72, the plug 76 is manufactured to be sufficiently porous to enable a gas flowing through the diffuser tube 74 to flow through the plug 76 and exit the plug 76 through its external surface defined at the upper end of the plug 76. To assist in grounding the molten metal within the crucible 52 for the furnace's induction circuit, the gas diffuser 72 may be equipped with electrodes (not shown) sized and configured to extend up through the particulate refractory material 62 and the base wall 68 of the crucible 52. The construction and materials suitable for the gas diffuser 72 are well known in the art, and therefore will not be described in any detail here. The gas diffuser tube 74 can be connected to a suitable gas supply (not shown), preferably with a gas-flow control system such as a pressure regulator on an argon-gas bottle, though more complicated control systems are foreseeable.

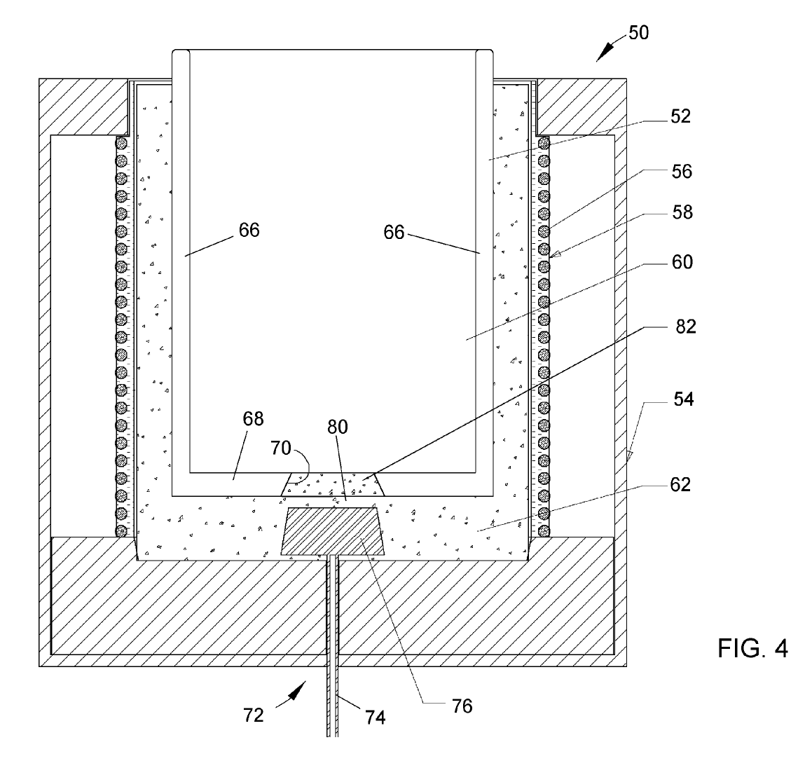

In order for the porous plug 76 to inject the inert gas into a molten metal within the crucible cavity 60, the crucible 52 is formed to have an opening 70, shown in FIG. 3 as being at the center of the crucible base wall 68. The porous plug 76 is preferably placed directly beneath the opening 70, as represented in FIG. 3. Prior to operating the furnace, the opening 70 is filled with a high-permeability material that forms a solid porous barrier 78 between the porous plug 76 and the molten metal within the crucible cavity 60. As represented in FIG. 4, the barrier 78 can be formed in situ by placing a particulate refractory material 82 in the opening 70 before melting metal in the crucible 52, such that the particulate refractory material 82 sinters while in contact by the molten metal to form the solid porous barrier 78. The barrier 78 is sufficiently porous to allow the inert gas to pass therethrough from the porous plug 76 and into the molten metal within the crucible cavity 60. The particulate refractory material 82 used to form the barrier 78 can be the same or different from the particulate refractory material 62 in which the crucible 52 is packed. The cross-sectional shape of the opening 70 (when viewed looking downward at the base 68 of the crucible 52) can be circular, though other shapes are possible. The cross-sectional width of the opening 70 can vary to accommodate various sizes of diffusers 72 and crucibles 52. The opening 70 in the crucible 52 is shown as being tapered to define a frustoconical shape that is smaller adjacent the crucible 52, providing better securement of the barrier 78 within the opening 70.

For the purpose of reducing the risk of damage to the porous plug 76 from heat and infiltration of molten metal if the solid barrier 78 were to crack, a layer 80 of the particulate refractory material 62 is represented in FIG. 3 as being between the top of the porous plug 76 and the bottom of the solid barrier 78. The refractory material layer 80 is porous and therefore allows the flow of inert gas from the porous plug 76 to the porous barrier 78, and in the event of infiltration of molten metal through a crack in the barrier 78 will form in situ a solid yet porous lining that continues to allow the flow of gas from the porous plug 76 to the porous barrier 78, similar to the lining 12 of FIG. 2. A suitable thickness for the refractory material layer 80 is approximately one-half inch (about one centimeter), though lesser and greater thicknesses are foreseeable.

In view of the above, the gas diffuser 72 can be effectively used to reduce impurities in a molten metal within the crucible 52, yet has the additional benefit of the crucible 52 being more durable than linings typically used with gas diffusers, for example, the lining 12 of FIG. 2. As such, the invention overcomes a significant shortcoming of using gas diffusers as discussed in reference to the furnace 30 of FIG. 2. Furthermore, because the crucible 52 is prefabricated and therefor not formed in situ, as is the lining 12 of FIG. 2, the first use of the crucible 52 does not require the very slow heating process required to form the lining 12 of FIG. 2. Furthermore, the strength, density and integrity of the crucible 52 can be determined during its carefully controlled manufacture instead of the sintering conditions within the furnace 50 and the packing conditions of the particulate refractory material 62 surrounding the crucible 52.

While the invention has been described in terms of a specific embodiment, it is apparent that other forms could be adopted by one skilled in the art. For example, the furnace 50, crucible 52, and gas diffuser 72 shown in FIG. 3 could differ in appearance and construction from the embodiment shown, and appropriate materials could be substituted for those noted. Therefore, the scope of the invention is to be limited only by the following claims.

1. A furnace comprising:
a furnace shell;
a solid crucible within the furnace shell, the crucible having side walls, a base wall, an opening in the base wall, and an interior cavity defined by the side and base walls, the crucible being formed of a nonmetallic refractory material;
a particulate refractory material packed beneath the base wall of the crucible and around the side walls of the crucible;
a gas diffuser beneath the crucible, the gas diffuser comprising a porous body and a conduit for delivering a gas to the porous body, the porous body being disposed in the particulate refractory material and beneath the opening in the base wall of the crucible, the porous body being sufficiently porous to enable a gas flowing through the conduit to also flow through the porous body and exit an external surface of the porous body;
a solid sintered porous barrier within the opening in the base wall of the crucible and between the porous body of the gas diffuser and the interior cavity of the crucible, the porous barrier being sufficiently porous to enable a gas exiting the porous body to also flow through the porous barrier and enter the interior cavity of the crucible; and
means for heating and melting a material placed in the interior cavity of the crucible.

2. The furnace according to claim 1, wherein the furnace is an induction furnace.

3. The furnace according to claim 1, wherein the opening in the base wall of the crucible is centrally located in the base wall.

4. The furnace according to claim 1, wherein the opening in the base wall of the crucible is tapered so as to be smaller adjacent the interior cavity of the crucible.

5. The furnace according to claim 1, wherein a portion of the particulate refractory material beneath the base wall of the crucible is disposed between the porous barrier and the porous body.

6. The furnace according to claim 1, wherein the crucible has a solid one-piece construction.

7. A crucible for use in a furnace comprising a gas diffuser that delivers a gas to a molten material within the furnace, the crucible comprising:
a nonmetallic refractory material that defines side walls, a base wall and an interior cavity defined by the side and base walls; and
an opening in the base wall through which a gas is able to pass from the gas diffuser when located beneath the crucible.

8. The crucible according to claim 7, further comprising a particulate refractory material packed within the opening in the base wall of the crucible.

9. The crucible according to claim 7, further comprising a solid sintered porous barrier within the opening in the base wall of the crucible, the porous barrier being sufficiently porous to enable a gas to flow through the porous barrier and enter the interior cavity of the crucible.

10. The crucible according to claim 7, wherein the opening is centrally located in the base wall of the crucible.

11. The crucible according to claim 7, wherein the opening in the base wall of the crucible is tapered so as to be smaller adjacent the interior cavity of the crucible.

12. The crucible according to claim 7, wherein the crucible has a solid one-piece construction.

13. A method of preparing and using a crucible, the method comprising:
placing a solid crucible within a furnace shell so that a first particulate refractory material is packed beneath a base wall of the crucible and around side walls of the crucible and a second particulate refractory material is packed within an opening in the base wall, the crucible being formed of a nonmetallic refractory material and having an interior cavity defined by the side and base walls;
heating the crucible to melt a material within the cavity and sinter the second particulate refractory material to form a solid sintered porous barrier within the opening in the base wall of the crucible; and
causing a gas to flow upward through the first particulate refractory material beneath the crucible, through the porous barrier within the opening in the base wall of the crucible, and into the molten material within the cavity of the crucible.

14. The method according to claim 13, wherein the first and second particulate refractory materials have the same composition.

15. The method according to claim 13, wherein the opening in the base wall of the crucible is centrally located in the base wall.

16. The method according to claim 13, wherein the opening in the base wall of the crucible is tapered so as to be smaller adjacent the interior cavity of the crucible.

17. The method according to claim 13, wherein a portion of the first particulate refractory material beneath the base wall of the crucible is disposed between the porous barrier and the porous body following the heating step.

18. The method according to claim 13, wherein the crucible has a solid one-piece construction prior to the heating step.

19. The method according to claim 13, wherein the gas flows from a gas diffuser beneath the crucible, the gas diffuser comprising a porous body and a conduit for delivering the gas to the porous body, the porous body being disposed in the first particulate refractory material and beneath the opening in the base wall of the crucible, the porous body being sufficiently porous to enable the gas flowing through the conduit to also flow through the porous body and exit an external surface of the porous body.

20. The method according to claim 13, wherein the method promotes the purity of the molten material within the crucible and articles cast from the molten material.
